(19) United States
(12) Patent Application Publication
(10) Pub. No.: US 2012/0270600 A1
(43) Pub. Date: Oct. 25, 2012

(54) CASE FOR PORTABLE ELECTRONIC DEVICE

(76) Inventor: STEVE TERRY ZELSON, Mamaroneck, NY (US)

(21) Appl. No.: 13/455,963

(22) Filed: Apr. 25, 2012

Related U.S. Application Data
(60) Provisional application No. 61/478,549, filed on Apr. 25, 2011.

(51) Int. Cl. H04M 1/02; H04N 13/02; H04N 5/225

(52) U.S. Cl. 455/556.1; 455/575.1; 348/376; 348/333.01; 348/47; 348/218.1; 348/335; 348/372; 348/E13.074; 348/E05.026

(57) ABSTRACT

This invention relates to a case for portable, handheld electronic devices such as those manufactured by Apple Inc., including the iPod touch, iPad and/or the iPhone, which case supplements the functional properties which are not present on a particular model of the portable, handheld electronic devices such as the iPod touch, iPad and/or the iPhone by providing an integrated speaker and/or microphone and/or at least one camera, in addition to providing the usual protective and/or cushioning aspects of an ordinary case.

### BACKGROUND

### Portable Electronic Devices

There are presently a wide variety of portable electronic devices. Many are cellphones such as the iPhone and others operated by the Android and similar operating systems. Other portable electronic devices exist, as well. The iPod, for example, is a portable, handheld music player made by Apple Inc. (see, for example, U.S. Pat. No. 7,697,281 and US2009/0245564). There are a number of different iPod devices, and configurations: the iPod shuffle, iPod nano, iPod classic and the iPod touch. There are also a number of other portable electronic devices made by Apple, including, the iPhone, a cellular mobile smart phone, and the iPad, a tablet computer. Billions of portable electronic devices, such as cellphones, have been sold worldwide. An estimated 45 million iPod touch and 60 million iPhones have been sold as of 2010. In 2010 alone it was reported that more than 14 million iPads have been sold.

All of the Apple devices can store and play music, or at least transmit digital music signals to earphones, headphones or loudspeakers. Some have built in speakers and/or microphones (US2009/0245564) whereas others do not. Some have front and/or back facing combined still-video cameras, such as the iPod touch (version 4) and iPhone 4, whereas others may not have any cameras, such as the iPad (version 1), or may only have a rear facing camera, for example, on the opposite side from the touch screen, as on the iPhone version 3. Some of these devices have built-in internal speakers, such as the iPod touch (version 4), or small external speakers, such as with the iPhone 4.

Some of the devices, such as the iPod touch and iPhone, have the capability to download programs or Apps (short for software “Applications”) from the Apple App store or directly from the internet, whereas others cannot, such as the iPod Classic. Some of the devices, such as the iPod touch, have the capability to join a wireless network using Wi-Fi whereas others do not have that capability, such as the iPod Shuffle and classic.

Some of the devices, such as the iPhone and iPod touch, have the ability, using an App, to become “virtual” or “soft” telephones using VoIP (otherwise known as Voice Over Internet Protocol) utilizing, for example, a Wi-Fi network connection to connect to the internet, whereas others, such as the iPod classic, do not have that capability. However, except for the iPhone, any of the other portable Apple electronic devices need to use a separate microphone, typically attached to wired earphones, in order to have a private conversation if the user does not want to have the conversation effectively broadcast over the device's speakers (similar to a speakerphone). Only the iPhone has a speaker located at the top of its touch screen adjacent to where a person's ear would be when holding the phone up to the side of their face when making a call. If that person was using an iPod touch like an ordinary cell phone, there would not be a speaker near their ear. In addition, only the iPhone has a microphone located at the bottom of the touch screen adjacent to where a person's mouth would be when making a call. If that person was using an iPod touch like an ordinary cell phone there would not be a microphone near their mouth, rather the microphone is on the other side near the top of the device.

Cameras can and have been placed on various parts of these kinds of mobile devices. Most cell phones have their camera on the opposite side of the device from their keyboard, number pad or touch screen. The iPhone 4 and iPad version 2 and iPod touch (version 4) also have front facing cameras (on the same side of the device as the touch screen) in order to facilitate video conference calls. The older versions of those devices either did not have cameras at all or only had rear facing cameras (on the side of the device opposite the touch screen) and did not have front facing cameras.

### Device Cases

Since portable electronic devices such as iPhones and iPods are relatively fragile and include glass as a major component, owners are often interested in protecting them by putting the mobile device in a case which would help prevent damage if, for example, they are accidentally dropped by the user. Such cases are disclosed in US2010/0240427; US2008/0302456 and U.S. D603,389. Some of the major case producers are Belkin, Griffin Technologies, Speck Products, iFrogz, iSkin, Incase, OtterBox, and Case-Mate. The vast majority of these cases simply contain the device within a hard or soft shell designed essentially to snuggly fit around the device. Many of these cases are made of hard plastic such as a polycarbonate or soft polymers such as silicone. Other cases are crafted from leather. Many have also incorporated screen protectors or clips to facilitate attachment to a belt or clothing. Most cases include openings at various points to allow the user to have access to the device controls, switches and connector ports.

Only a very few cases for these mobile electronic devices include any functional components beyond the protective cover itself. One case provides a stand so the portable electronic device can be positioned easily for viewing (USP 2010/0072334). Another attachment, not strictly a case, includes a supplemental battery for the device (the Exolife by Exogear) (see also, U.S. Pat. No. 7,782,610). Another attachment include a solar cell arrangement to help assist in charging the device itself (the Surge by Novothink). The Surge, however, relies on the user to plug in a separate headphone-earphone/microphone combination but does not include its own microphone or speaker or camera. Another case converts an iPod touch into a cellular telephone with a built in 3G to Wi-Fi hot spot (the ZTE Peel by Sprint). The ZTE Peel, however, also relies on the user to plug in a separate headphone-earphone/microphone combination as it does not include its own microphone or speaker or camera or keyboard. Dobi Designs produces a sliding Bluetooth Keyboard case for the iPhone.

None of the cases in the prior art, however, provide a microphone and/or speaker and/or keyboard and/or one or more cameras as part of their case enclosing an Apple iPod or iPhone or iPad.

### SUMMARY

It is therefore an object of this invention to provide a case for a portable electronic device, such as an iPod touch, an iPhone, an iPad or a cellphone operated by the Android operating system (or any operating system that provides similar capabilities), with features not existing on the device itself or on the devices and broken or to add to those already present. More specifically, in one aspect this invention would be a case for a portable electronic device comprising a compartment to surround said electronic device at least in part, or having a shape so as to securely hold said device, and a speaker. In another aspect, the case would further comprise a microphone.

In an additional aspect, the case of this invention would further comprise at least one camera, either facing the user on the same side as the number pad or touch screen or on the opposite side facing away from the user. In a another aspect, the case of this invention would two cameras on one side of the case, preferably the side pointing away from the user, in order to enable the user to take 3D or stereoscopic still or video pictures. In one embodiment, one of these cameras could be the existing one on the device and the second on the case. In a different embodiment, both additional cameras could be on the case itself. It is also within the scope of this invention that there is a third camera present on the case on the same side as the keyboard or number pad or touch screen, enabling the user to partake in video conferences. A further aspect would include a technically advanced camera on the side opposite the touch screen, which camera would have interchangeable lenses, viewfinders, variable apertures and other features similar to an SLR camera. In another aspect, the case would further comprise a keyboard together with the microphone and/or speaker and/or camera. The case of this invention can include any of these individual components, the speaker(s), microphone(s) or camera(s) either alone or in combination with one another and/or with a keyboard.

The above summary does not include an exhaustive list of all aspects of the invention. It is contemplated that the invention includes all the configurations that can be practiced from all suitable combinations of the various components summarized above, as well as those disclosed in the Detailed Description below and particularly pointed out in the claims. Such configurations and combinations may have particular advantages not specifically recited in the claims.

### BRIEF DESCRIPTION OF THE DRAWINGS

FIG. 1 is a perspective view of the front of the case of this invention having the microphone and speaker integrated therein.

FIG. 2 is a perspective view of the front of another embodiment of the case of this invention having the microphone, speaker and camera integrated therein.

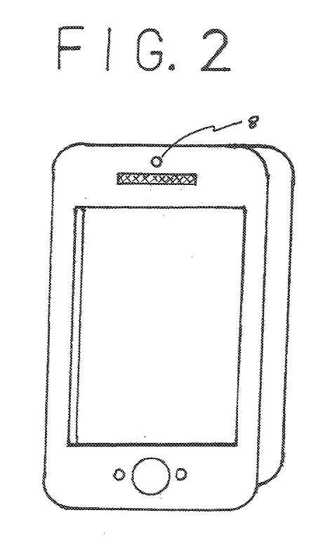

FIG. 3 is a perspective view of the rear of the case of this invention having a camera integrated therein and showing an iPhone, with it's camera and flash exposed, within said case.

### DETAILED DESCRIPTION

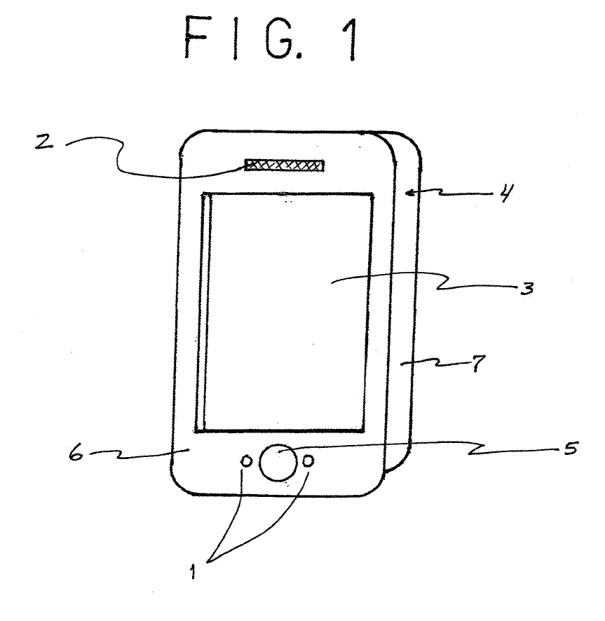

The claimed invention provides a number of functions and enhancements over existing cases. For example, with the case invention as claimed herein, as shown in FIG. 1, a user would be enabled to convert an iPod touch into a spare phone that they could carry with them at all times in the event their regular cellphone battery ran out of power, and would be a cellphone that would work in any country, as long as there was a WiFi connection. The user would not have to carry separate earphones with a microphone to use the devise as a cellphone. In addition, an iPod touch using a case of the claimed invention could be used as a starter cellphone for a child. Such a cellphone would not incur expensive monthly charges because the connection could be a VoIP connection over the Internet.

In another embodiment, a person using the case of the claimed invention having a front facing camera 8 could convert an older model of the iPhone or iPod touch or iPad which does not have such a camera into one that was capable of videoconferencing. In another embodiment of this invention, a user could have two cameras 10 and 12 on the side 9 opposite the touch screen either with a case having both cameras on the one side or a second camera 12 in addition to the one already present on the cellphone 10 together with its flash 11 iPod touch or iPhone 13 (positioned preferably so as to maximize the distance between the cameras so as to maximize the 3D effect), enabling the user to take stereoscopic 3D photographs or videos. These 3D images, which can also be recorded in high definition format or in a manner which would later be utilized together with the 3D display, can later be replayed on the device itself or on a 3D capable device such as a 3D TV, with or without 3D glasses (e.g., glasses having different color filters or polarization for each eye), depending on the specific 3D technology utilized to capture the image.

In a further embodiment, the case of the claimed invention could include a camera with an optical or digital zoom lens or on enabling the changing of the lenses (e.g., telephoto or wide angle) or filters or of the camera having different apertures or shutter speeds. In another embodiment the case could also be formed to include an optical or digital viewfinder and/or a shutter button or trigger for the digital camera. All of these embodiments could also be combined with a separate keyboard also on the case. In this embodiment, the portable electronic device essentially becomes the electronic controls and memory for the sophisticated digital camera.

### Case Configuration and Structure

The means by which the case of the present invention encloses and protects a portable electronic device such as an iPhone version 3 and 4, an iPod and an iPad or a cellphone such as one operated by the Android system, are described herein.

The case itself 4 can be made of plastic including hard plastic such as a polycarbonate or soft polymers such as silicone. It could also be crafted from synthetic and/or natural fabric (such as ballistic nylon or cotton), metal, wood or leather. The case could also incorporate a screen protector or clips to facilitate attachment to a belt or clothing. The case would include openings at various points to allow the user to have access to a touch screen 3, portable electronic device controls, switches, master button 5, and connector ports. The case would also be shaped so as to securely hold said device. This can be accomplished in a wide number of ways including simply containing the device within a hard or soft shell designed essentially to snuggly fit around the device. The case can also have an opening on any of its sides 7 covered by a movable retention flap or not, in order allow the portable electronic device to slip into a compartment formed within the case or the case could be sufficiently pliable to enable it to be stretched around the device so as to envelop it. Any of these case configurations can be designed so the front of the case 6 can accommodate an integrated speaker 2 and/or microphone 1 and/or at least one camera 8. Any of these case configurations can also be designed to accommodate a power source such as a battery or wire to connect to an external power source or the device itself so as to power the integrated speaker and/or microphone and/or at least one camera. In a preferred embodiment the battery or wire to connect to an external power source, the speaker and/or microphone and/or at least one camera, are all integrated into the case itself. In another preferred embodiment, one or more of the components including the battery or wire to connect to an external power source, the speaker and/or microphone and/or at least one camera, are all attached to the external surface of the case or are contained within a separate compartment on the case itself.

The location of the components on the case are also related to their functions. For example, it is preferred that the speaker on the case is located at the opposite end of the case from the microphone. This facilitates the ability of the user to hold the device in the case of this invention as they would hold a normal cellphone to their ear. The location of the cameras also impacts upon their function. In a preferred embodiment, one camera is located on the same side as the touch screen, thereby enabling the user to conduct video conferences using it. Another camera preferentially can be located on the other side of the device from the screen enabling the user to take still and/or video pictures while viewing the framed, proposed photo or video on the device screen prior to taking the picture or video.

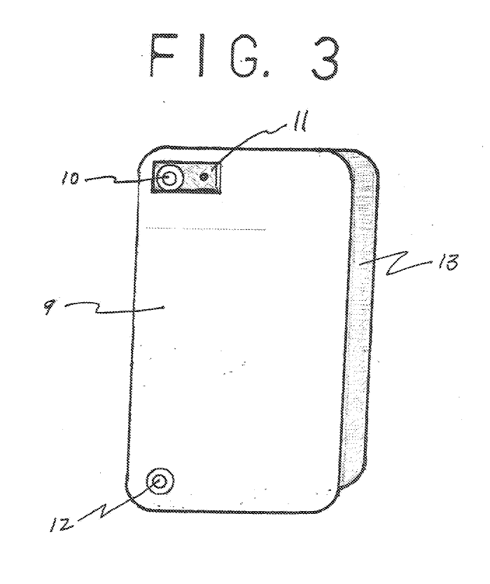

If there are two cameras on the opposite side of the device, either one from the device itself or both on the case itself, the user would be enabled to take 3D stereoscopic photos and/or video with the device. In this embodiment, it is preferable that the two cameras be located as far apart as possible so as to maximize the stereo effect. In this embodiment, for example, the two cameras would preferably be located at either ends of the case with both cameras preferably facing the same direction (see FIG. 3). 3D stereoscopic technology has been in use for decades, although not in connection with a case for portable electronic devices, and there are many ways in the art to product 3D images, video and film. Many of these techniques and technologies are described on the Wikipedia site, under the topic “3-D Film” (see www.Wikipedia.org/wiki/3-D_film; content incorporated herein by reference). Many of the technologies described on that site, such as using anaglyph images, polarization systems using polarized images or spectral comb filtering or wavelength multiplex visualization are suitable and preferred for use with this claimed camera case invention. The stereoscopic image would be viewable on the portable electronic device itself or on another display such as a TV capable of displaying 3D images. The user may have to wear special glasses to view the 3D images, depending on the type of technology used to capture the 3D. It may also be desirable cover the lens of the camera case of this invention with removable polarized filters or software to digitally simulate polarization so as to capture different polarized images in each camera if a technique utilizing polarization is desired.

The components of the case of this invention can be connected to the portable electronic device and powered in a variety of ways. In one preferred embodiment, the speaker and microphone components are connected by a wire to an audio jack plug on the portable electronic device. In another embodiment the speaker and microphone components are connected to the device by a Bluetooth wireless connection. In a further embodiment, case further comprises a Bluetooth wireless adapter as well as a battery for the Bluetooth wireless adapter. In one embodiment the components of the case of this invention, such as the microphone, speaker and camera(s), are powered by a battery present on the case. In another embodiment, the power to the components, including the Bluetooth wireless adapter is provided by a solar cell charging panel on the exterior of said case. In an additional embodiment, the case further comprises a keyboard in combination with microphone, speaker and/or camera(s).

### Camera

One of the preferred components of the case of this invention for a portable electronic device is a camera. In one embodiment the case comprises at least one camera and a compartment to hold said electronic device. It is preferred that the camera is a digital camera. It is also within the scope of this invention that said digital camera is a video camera. In an embodiment of this invention the electronic device has a touch screen input surface and said video camera is a front facing camera on the same side as said touch screen. In a further embodiment the case comprises another video camera which is rear facing, on the opposite side of the device from the other video camera. In another embodiment the case comprises a camera with a zoom lens. The case camera of this invention can also have any of the following features either alone or in combination: a removable lens (e.g., telephoto, zoom, wide-angle—all like an SLR camera), light filters, an adjustable aperture, adjustable shutter speeds, shutter button, optical viewfinder and/or digital viewfinder. The case camera of this invention can also have two cameras on the same side of the case. The two cameras can capture a stereo/3D (3-dimensional) image (in still or video; normal or high-definition video) if they are positioned so they capture an image from a different perspective from each other. These cameras can be used together on the case with one on the opposite side used for video conferencing. In a preferred embodiment, the case camera of this invention can be used with a portable electronic device such as a cellphone, which has or does not have a camera, such as an iPhone or a cellphone operated by the Android or similar operating system. In another preferred embodiment, the case camera of this invention can be used with a portable electronic device such as an iPod touch or iPad. In a further preferred embodiment, the case camera of this invention further comprises a battery for the camera. The case camera of this invention is preferably connected to the portable electronic device by a Bluetooth wireless connection, for the transmission of images and information, and preferably also comprises a Bluetooth wireless adapter and a battery for said Bluetooth wireless adapter. In another preferred embodiment, the case camera of this invention further comprises a solar cell charging panel on the exterior of said case for said camera.

The digital camera preferred for use with the case camera of this invention are utilized in the in the iPhone and iPad and iPod touch are of the kind typically in use in many cellular telephones, laptops and as accessories to be added as a stand-alone camera (typically called a “webcam” such as those produced by Logitech) to a laptop or desktop today, such as any one of a number of CMOS image sensors manufactured by OmniVision, a providers of these sensors to the mobile phone market, or by Pixel Plus, another supplier of CMOS image sensors for the mobile phone market. However, as noted above, not all models of iPods and iPhones have a front and back camera and some models of iPads and iPods have no cameras at all. The camera element could also be the DC531110 High Speed CMOS Color Digital Camera by View Solutions, Inc. Cameras can be connected to an iPad, for example, using Apples iPad Camera connection kit. This is essentially an adapter that allows users to connect a camera to the iPad via the 30 pin connector on the iPad and a USB port. The cameras can be powered directly by the portable electronic device when it is integrated within it, by a wire from the device, by batteries internal to the camera or by a power cord from the camera to power source such as a wall outlet.

More specifically, Photographic equipment such as digital cameras and camcorders and certain models of iPhones, iPods and iPads contain electronic image sensors that capture light for processing into a still or video image. An image sensor is a semiconductor device for converting an optical image into electrical signals. There are two primary types of electronic image sensors, charge coupled devices (CCDs) and complimentary metal oxide semiconductor (CMOS) sensors. CMOS imaging technology has become increasingly the technology of choice. A CMOS image sensor transforms optical images to electrical signals using CMOS technologies. A CMOS image sensor senses an image using a photodiode and a MOS transistor in each pixel for detecting light signals in a switching mode. The CMOS image sensor employs a switching method that sequentially generates signals using MOS transistors. The image sensors include rows and columns of pixels. The pixels generate small photo signals proportional to light reflected from an object to be imaged. The photo signal is read and processed by signal processing circuitry to create an image representing the object. Generally, the CMOS image sensor includes a plurality of unit pixels. Each of the unit pixels also includes a light sensing element and a plurality of transistors. The light sensing element such as a photodiode senses incident light beam to generate photoelectric charges corresponding to an amount of the incident light beam. The transistors perform switching operations to control a transfer of the photoelectric charges.

### Communication Services and Modes

The case of this invention operates as a cellphone with the microphone and speaker using WiFi. Wi-Fi is any of several standards for short-range wireless data transmission (for example, IEEE 802.11g and n). The term “Wi-Fi” was reportedly derived from “Wireless Fidelity”, after the sound equipment classification term high fidelity. Broadly stated, VoIP or Voice Over Internet Protocol is a telecommunications system that uses the Internet or other Internet Protocol networks to transmit telephone calls. Other terms often used synonymously with VoIP are IP telephony, Internet telephony, voice over broadband (VoBB), broadband telephony, and broadband phone. Internet telephony refers to communications services—voice, fax, SMS, and/or voice-messaging applications—that are transported via the Internet, rather than the public switched telephone network (PSTN). An iPhone, iPod touch or iPad could link to the internet via wifi to make a VoIP call.

Voice over Internet Protocol (Voice over IP, VoIP) is any of a family of methodologies, communication protocols, and transmission technologies for delivery of voice communications and multimedia sessions over Internet Protocol (IP) networks, such as the Internet. Other terms frequently encountered and often used synonymously with VoIP are IP telephony, Internet telephony, voice over broadband (VoBB), broadband telephony, and broadband phone.

Popular VOIP providers include Skype and Line2. Skype and Line2 allow computer and electronic devices such as the iPod touch and the iPhone to make telephone calls over the Internet via VOIP. The iPod touch versions 1, 2 and 3 (none of which include an internal microphone) require a headphone with microphone in order to use Wi-Fi access to the internet to make telephone calls. The iPod touch, version 4, however, can make these calls via Wi-Fi connection to the internet utilizing its own internal speaker and internal microphone; however, these conversations are, in effect, speaker phone conversations because the sound from the call is broadcast out to the public. In order to make telephone calls with the iPod touch version 4, the iPod touch has to be held in front of the user, or in a manner allowing the omnidirectional microphone on the back side of the device (opposite the touch screen) to pick up the vocal sounds, if the user is not using the headphone and microphone combination. The other iPod touch versions can be held in any manner as long as the user is utilizing the headphones and microphone, however, it is not held in a normal cell phone like fashion with the phone held to the side of the face with one end adjacent to the ear and the end adjacent to the mouth. This is because the iPod touch does not include a speaker adjacent to the upper portion of the device near where the earpiece is located on the iPhone (the single speaker is located on the bottom of the device) nor does it have a microphone at the bottom of the device where it is typically located on the iPhone and other cell phones. The use of earpiece-microphone combinations and speaker phones is inconvenient and impractical particularly when one wants to make a private conversation or when one is in the situation where earphone are not available. An iPod touch or iPhone which uses the case of this invention, however, would have a microphone and speaker located in a normal position (microphone near mouth and speaker near ear) for use by someone using it to make a VoIP call. It is also preferred that during a call software locks or disables the screen on said iPod touch or iPhone when holding the phone to the user's cheek so as to prevent the user from accidently activating any buttons on the screen itself during the call.

### Bluetooth

The components of the case of this invention preferably connect to the portable device using Bluetooth. Accessories are often wirelessly connected to an iPhone, iPod touch, iPad or Android devices using Bluetooth technology. According to Bluetooth SIG, Inc., Bluetooth wireless technology is a short-range communications technology intended to replace the cables connecting portable and/or fixed devices, such as a cellphone or keyboard, while maintaining high levels of security. Connections between Bluetooth enabled electronic devices allow these devices to communicate wirelessly through short-range, networks known as piconets. Each device in a piconet can also simultaneously communicate with up to seven other devices within that single piconet and each device can also belong to several piconets simultaneously. This means the ways in which you can connect your Bluetooth devices is almost limitless. The range of Bluetooth is a minimum range of 10 meters or 30 feet, but there is no set limit. Bluetooth operates in the unlicensed industrial, scientific and medical (ISM) band at 2.4 to 2.485 GHz, using a spread spectrum, frequency hopping, full-duplex signal at a nominal rate of 1600 hops/sec.

Bluetooth headsets are typically used with iPhones and can also be utilized with certain applications on the iPod touch and iPad. A very popular way to have hands free conversations using a cell phone is to use an earpiece which utilizes Bluetooth technology to connect to the cellphone. Examples of these Bluetooth headsets are the Aliph Jawbone, The Plantronics Voyager Pro Plus, The Motorola Finiti, The BlueAnt Q2, the Sound ID 510 and The Jabra Extreme. The case of this invention would essentially have integrated a Bluetooth headset into it where the components (speaker and microphone, Bluetooth transmission components and battery) are located separately in the case.

Microphones and Speakers for Apple iPods and iPhones

There are dozens of products to which iPods and iPhones can be connected or “docked” which enable amplified of music, for example, to be played from the device. These products, for example, include stereos and clock radios. There are also separate external speakers and televisions to which the iPods and iPhones can stream music using Wi-Fi and Bluetooth. However, none of these products provide speakers as part of a case enclosing and/or protecting the iPods or iPhones.

In addition, there are separate microphones which can plug into the iPods such as the Touchmod microphone by Ridax, which plug into the Apple 30 pin connector, for use with VOIP applications. There are numerous other microphone-earphone combinations and at least one separate microphone product (the Switcheasy ThumbTacks) which plug into the iPods and iPhones headphone jack. These microphone-earphone (also known as in-ear headphones) typically have frequency response of about 5 Hz to 21 kHz; an impedance (at 100 Hz) of about 23 ohms; a sensitivity (at 100 Hz) of about 109 dB SPL/mW; a cable length of about 1000 mm from the audio jack to the splitter and about 300-350 mm to the earpiece; and a weight of about 0.3-0.7 ounces.

The microphone and/or speaker of the case of this invention can be powered directly by the portable electronic device when integrated within it, by an external wire from the device (such as an earphone wire), by batteries such as those internal to the microphone or separately located on the case and/or speaker or by a power cord from the microphone and/or speaker to power source such as a wall outlet.

### Power Sources

Various batteries, or a direct connection to a power outlet such as a wall plug, can be used to provide power to the microphone, speaker, camera(s) and/or keyboard of this invention. Batteries are preferred with the case of this invention so as to enable portability of the device. The batteries can be the ones used to power the portable electronic device itself if the microphone, speaker, camera(s) and/or keyboard are connected by a Wire to the portable electronic device itself. Alternatively, the battery can be separate from the portable electronic device and be adjacent to or integrated into the case itself. There are a wide variety of kinds of batteries or power sources that could be used with the present invention including a lead acid battery, a NiCd (nickel-cadmium) battery, a NIMH (nickel-metal hydride) battery, a silver-zinc oxide battery, and preferably, a lithium ion battery, etc. The lead acid battery, in which lead dioxide is used as a positive active material, lead is used as a negative active material and dilute sulfuric acid is used as an electrolyte, has an operating voltage of 2V. The lead acid battery has a good balance in quality, reliability and cost, and therefore is widely used for a motor vehicle, an electric vehicle, a UPS (uninterrutible power supply), etc. The NiCd battery, in which nickel oxyhydroxide is used as a positive active material, cadmium is used as a negative active material and potassium hydroxide aqueous solution is used as an electrolyte, has features of a small internal resistance, allowability of large current discharge, long cycle life, resistance to excessive charge/discharge, and wide range of temperatures. In Ni-MH battery, nickel oxyhydroxide is used as a positive active material, a hydrogen storage alloy is used as a negative active material and potassium hydroxide aqueous solution is used as an electrolyte. The Ni-MH battery having a feature of a high energy density has been mainly put into practice for various consumer appliances. The silver oxide zinc battery has features of a high output and a high energy density, but a defect of high cost. Its larger scale type has been mainly used for space and deep-sea equipment, whereas its small scale type has been widely used for a watch or an electronic calculator. The lithium ion battery, which has features of a high operating voltage, high energy density and no memory effect, has been widely used for consumer appliances. The consumer type AA or AAA sized nickel metal-hydride (NiMH) or nickel cadmium (NiCd) rechargeable batteries have also been widely used. Various electrical appliances, such as digital cameras, video recorders, AV equipment, notebook computers, PDAs, cellar phones and toys, require high capacity and reliability AA or AAA sized rechargeable battery cells for operation. Most preferably, lithium ion batteries would be used to power the components of the case of this invention.

While there has been described what is believed to be the preferred embodiment of the invention, those skilled in the art will recognize that other and further modifications may be made thereto without departing from the spirit of the present invention, and it is intended to claim all such changes and modifications as fall within the true scope of the invention.

What is claimed is:

1. A case for a portable electronic device comprising a compartment to hold said electronic device and a speaker.

2. The case of claim 1, further comprising a microphone.

3. The case of claim 2, further comprising at least one camera.

4. The case of claim 2, further comprising a keyboard.

5. The case of claim 1, further comprising a battery to power said speaker.

6. The case of claim 2, further comprising a battery to power said speaker and microphone.

7. The case of claim 3, further comprising a battery to power said speaker, microphone and camera.

8. The case of claim 2, wherein the speaker is located at the opposite end of the case from the microphone and on the same side of the case as the microphone.

9. The case of claim 1, wherein said device is an iPod touch, and iPhone, iPad, or a cellphone operated by the Android operating system.

10. The case of claim 2, further comprising a wire connecting the speaker and microphone to an audio jack plug on the portable electronic device.

11. The case of claim 2, wherein said speaker and microphone are connected to the device by a Bluetooth wireless connection.

12. The case of claim 2, wherein said case further comprises a Bluetooth wireless adapter and a battery for said Bluetooth wireless adapter.

13. A case for a portable electronic device comprising at least one camera and a compartment to hold said electronic device.

14. The case of claim 13, wherein the camera is a digital camera.

15. The case of claim 13, wherein said digital camera is a video camera.

16. The case of claim 15, wherein said electronic device has a touch screen input surface and said video camera is a front facing camera on the same side as said touch screen.

17. The case of claim 13, further comprising another video camera which is rear facing on the opposite side of the device from the other video camera.

18. The case of claim 17, further comprising a camera with a zoom lens.

19. The case of claim 13, further comprising two cameras on the same side of the case.

20. The case of claim 19, wherein the cameras are positioned so they capture an image from a different perspective from each other.

21. The case of claim 19, wherein the cameras capture images in 3D format.

22. The case of claim 19, wherein the cameras are video cameras.

23. The case of claim 22, wherein the cameras capture images in high-definition video.

24. The case of claim 19, wherein one of the cameras is on the case and one of the cameras is on the device.

25. The case of claim 13, further comprising a camera having a removable lens.

26. The case of claim 13, further comprising a camera having a lens and light filters.

27. The case of claim 13, further comprising a camera having an adjustable aperture.

28. The case of claim 13, further comprising a camera having adjustable shutter speeds.

29. The case of claim 13, further comprising an optical viewfinder.

30. The case of claim 13, further comprising a digital viewfinder.

31. The case of claim 13, further comprising a shutter button for the digital camera.

32. The case of claim 13, wherein the electronic device is a cellphone.

33. The case of claim 32, wherein the electronic device is a cellphone that has a camera.

34. The case of claim 13, wherein the electronic device is an iPod touch, and iPhone, iPad, or a cellphone operated by the Android operating system.

35. The case of claim 13, wherein said case further comprises a battery for said camera.

36. The case of claim 13, wherein said camera is connected to the portable electronic device by a Bluetooth wireless connection.

37. The case of claim 13, wherein said case further comprises a Bluetooth wireless adapter and a battery for said Bluetooth wireless adapter.

38. The case of claim 13, wherein said case further comprises a solar cell charging panel on the exterior of said case for said camera.

39. The case of claim 11, wherein said case further comprises a solar cell charging panel on the exterior of said case.

40. The case of claim 7, wherein said case further comprises a solar cell charging panel on the exterior of said case.
